(19) United States
(12) Patent Application Publication
(10) Pub. No.: US 2024/0310200 A1
(43) Pub. Date: Sep. 19, 2024

(54) Method and System for Flowrate Measurement Correction of a Flowmeter

(71) Applicant: ABB Schweiz AG, Baden (CH)

(72) Inventors: Subhashish Dasgupta, Bangalore (IN); Xiaotang Gu, Stroud (GB); Edis Loveless, Bristol (GB); Raghu Kumar NV, Mysore (IN)

(73) Assignee: ABB Schweiz AG, Baden (CH)

(21) Appl. No.: 18/668,681

(22) Filed: May 20, 2024

Related U.S. Application Data
(63) Continuation of application No. PCT/IB2022/061219, filed on Nov. 21, 2022.

(30) Foreign Application Priority Data
Nov. 21, 2021 (IN) 202141053489

(51) Int. Cl. G01F 25/10

(52) U.S. Cl. CPC G01F 25/10

(57) ABSTRACT

A system and method for correcting flowrate measurements of a flowmeter includes receiving at least one of flow distorting parameters, flowmeter physical and operational parameters, a current flowrate value measured by the flowmeter, and fluid physical properties; determining a flow regime based on the current flowrate value; selecting at least one flow equation based on the determined flow regime; computing an output signal based on the selected flow equation and at least one of electromagnetic equations and/or physics-based equations, the flow distorting parameters, the flowmeter physical and operational parameters, and the fluid physical properties; determining a corrected calibration factor using the computed output signal and the current flowrate value; and transmitting the corrected calibration factor for correcting flowrate measurement of the flowmeter.

### CROSS-REFERENCE TO RELATED APPLICATIONS

The instant application claims priority to Indian patent application Ser. No. 20/214,1053489, filed Nov. 21, 2021, and to International Patent Application No. PCT/IB2022/061219, filed Nov. 21, 2022, each of which is incorporated herein in its entirety by reference.

### FIELD OF THE DISCLOSURE

The present disclosure generally relates to flowmeters and, more particularly, to systems and methods for correcting flowrate measurements of a flowmeter.

### BACKGROUND OF THE INVENTION

A flowmeter is an instrument used for measuring flowrate of fluids and gases in industries and homes. The term flowrate refers to the speed at which a fluid moves through a structure (e.g., pipe) at a given time. Flowmeters are capable of measuring flowrates for almost all kinds of fluids including, but not limited to, water, steam, acids, alkalis, slurries, gases, and many others. Flowmeters can be classified into different types based on their uses and applications. Some popular types of flowmeters may include electromagnetic flowmeter, ultrasonic flowmeter, vortex flowmeter, Coriolis meter, thermal mass flowmeter, turbine flowmeter several other flowmeters (or other sensors like temperature sensors).

A measurement accuracy of a flowmeter may indicate as how close the measurement of flowmeter is to a true value. The measurement accuracy of the flowmeter may gradually degrade over time due to various factors such as, but not limited to, deposits on internal surfaces, contamination, aging, chemical attacks, internal and external damages etc. However, a major cause of concern in functioning of the flowmeter is degradation in the measurement accuracy due to flow distortion or velocity profile distortion because of presence of upstream flow distorting features (such as, but not limited to, bends, valves, strainers, elbows, and T-junctions, etc.) and also due to unexpected changes in physical properties of fluids passing through the flowmeter.

In existing systems, several techniques have been implemented to mitigate errors induced in flowmeter readings due to flow distorting features. For instance, conditioning the fluid flow prior to its entry into flowmeter section, has been a successful method. However, the method results in pressure drop, calls for changes in the flowmeter cross section, and/or usage of additional components. Thus, it is a challenge to design a universal flow conditioner for different types of disturbances (such as disturbance due to a bend, disturbance due to a valve etc.). An extreme situation commonly encountered is availability of not more than zero-to-one-time pipe diameter distance from an upstream bend for installing the flowmeter. Few techniques involve reforming the flow by using a flow reformer (e.g., a perforated plate) at a flowmeter inlet. However, reforming the flow by using the flow reformer at the flowmeter inlet induces high pressure drop and is therefore not a feasible method.

Also, non-invasive techniques to overcome flow distortion effects have been tested and implemented. However, these techniques involve additional components and call for undesirable changes to hardware of the flowmeter. For example, multiple electrodes can be used to obtain several sets of readings at various levels within a flowmeter pipe and averaging the readings to overcome flow distortion effects. However, the techniques expose the flowmeter to higher chances of leakage and incur additional hardware requirements with associated higher costs. Further, extended electrodes can be used to obtain a flow-average reading but are prone to other noise issues like particulate bombardment on electrode surfaces.

A limited number of attempts have been made in developing techniques to correct errors in flowmeter readings (or to improve flowmeter measurement accuracy) by calculations, using models to resolve physics of the flowmeter while accounting for flow distorting features. These models usually solve physics-based equations for calculating a corrected calibration factor for the flowmeter under field conditions. However, no model accounts for change in fluid physical properties and their impact on measurement accuracy. Consequently, the flowmeter fails to provide accurate reading of flowrate measurement. However, measurement of the accurate flowrate is critical in industrial processes to ensure optimization of such industrial processes and flowrate measurement by the flowmeter. Hence, it is required to determine an accurate calibration factor for the flow distortion to provide accurate reading of flowrate measurement and reduce adverse impact on industrial processes.

The information disclosed in this background section is only for enhancement of understanding of the general background of the invention and should not be taken as an acknowledgement or any form of suggestion that this information forms the prior art already known to a person skilled in the art.

### BRIEF SUMMARY OF THE INVENTION

Based on the foregoing, there exists a need for further improvements in the technology, especially for techniques that can provide accurate reading of flowrate measurement and reduce adverse impact on industrial processes by determining a corrected calibration factor for the flowmeter while taking into account various factors including the change in fluid physical properties. One or more shortcomings discussed above are overcome, and additional advantages are provided by the present disclosure. Additional features and advantages are realized through the techniques of the present disclosure. Other embodiments and aspects of the disclosure are described in detail herein and are considered a part of the disclosure.

An objective of the present disclosure is to determine a calibration factor for a flowmeter while considering various factors including a change in fluid physical properties.

Another object of the present disclosure is to provide accurate reading of flowrate measurement and reduce adverse impact on industrial processes by correcting the flowrate measurements of a flowmeter.

According to an aspect of the present disclosure, methods and systems are provided for correcting flowrate measurement of a flowmeter. In a non-limiting embodiment of the present disclosure, the present application discloses a method for correcting flowrate measurement of a flowmeter. The method may comprise receiving at least one of flow distorting parameters, flowmeter physical and operational parameters, a current flowrate value measured by the flowmeter, and fluid physical properties. The method may further comprise determining a flow regime based on the current flowrate value and selecting at least one flow equation from a plurality of flow equations based on the determined flow regime. The method may further comprise computing an output signal based on the selected flow equation and at least one of electromagnetic equations and/or physics-based equations, the flow distorting parameters, the flowmeter physical and operational parameters, and the fluid physical properties. The method may further comprise determining a corrected calibration factor using the computed output signal and the current flowrate value and transmitting the corrected calibration factor for correcting flowrate measurement of the flowmeter.

In another non-limiting embodiment of the present disclosure, the flow distorting parameters comprise a shape of a flow distorting feature at an upstream or a downstream of the flowmeter, a size of the flow distorting feature at the upstream or the downstream of the flowmeter, an orientation of the flow distorting feature with respect to the flowmeter, and the distance of the flow distorting feature from the flowmeter.

In another non-limiting embodiment of the present disclosure, the flowmeter physical parameters comprise a shape and a size of flowmeter components.

In another non-limiting embodiment of the present disclosure, determining the flow regime may comprise calculating Reynolds number based on the current flowrate value; and selecting a flow regime from a plurality of flow regimes based on the calculated Reynolds number.

In another non-limiting embodiment of the present disclosure, the plurality of flow regimes comprises a laminar flow regime, a transitional flow regime, and a turbulent flow regime.

In another non-limiting embodiment of the present disclosure, selecting the flow regime from the plurality of flow regimes may comprise: selecting the laminar flow regime when the Reynolds number is less or equal to a first value; selecting the transitional flow regime when the Reynolds number is between the first value and a second value, where the second value is greater than the first value; and selecting the turbulent flow regime when the Reynolds number is greater than or equal to the second value.

In another non-limiting embodiment of the present disclosure, determining the corrected calibration factor using the computed output signal and the current flowrate value may comprise dividing the computed output signal by the current flowrate value to determine the corrected calibration factor.

In another non-limiting embodiment of the present disclosure, selecting the at least one flow equation from the plurality of flow equations may comprise selecting a laminar flow momentum equation and associated equations when the flow regime is a laminar flow regime; selecting a transition fluid flow momentum equation and associated equations when the flow regime is a transitional flow regime; and selecting a turbulent flow equation and associated equations when the flow regime is a turbulent flow regime.

In another non-limiting embodiment of the present disclosure, the present application discloses a flowrate correction system for correcting flowrate of a flowmeter. The flowrate correction system may comprise a processor; and a memory communicatively coupled to the processor, where the memory stores processor-executable instructions, which on execution, cause the processor to receive at least one of flow distorting parameters, flowmeter physical and operational parameters, a current flowrate value measured by the flowmeter, and fluid physical properties. The instructions may further cause the processor to determine a flow regime based on the current flowrate value and select at least one flow equation from a plurality of flow equations based on the flow regime. The instructions may further cause the processor to compute an output signal based on the selected flow equation at least one of electromagnetic equations and/or physics-based equations, the flow distorting parameters, the flowmeter physical and operational parameters, and the fluid physical properties. The instructions may further cause the processor to determine a corrected calibration factor using the computed output signal and the current flowrate value and transmit the corrected calibration factor for correcting flowrate measurement of the flowmeter.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE SEVERAL VIEWS OF THE DRAWING(S)

Having thus described example embodiments of the present disclosure in general terms, reference will now be made to the accompanying drawings, which are not necessarily drawn to scale.

FIG. 1(a) illustrates an exemplary arrangement 100-1 showing a section of a flow pipe with a flowmeter mounted near a valve, in accordance with some embodiments of the present disclosure.

FIG. 1(b) illustrates an exemplary arrangement 100-2 showing a section of a flow pipe with a flowmeter mounted near a bend, in accordance with some embodiments of the present disclosure.

FIG. 2 illustrates an exemplary environment 200 for correcting flowrate measurement of a flowmeter, in accordance with some embodiments of the present disclosure.

FIG. 3 illustrates a block diagram 300 of flowrate correction system for a flowmeter, in accordance with some embodiments of the present disclosure.

FIG. 4 illustrates a flowchart 400 illustrating a method for flowrate correction of a flowmeter, in accordance with some embodiments of the present disclosure.

It should be appreciated by those skilled in the art that any block diagrams herein represent conceptual views of the illustrative systems embodying the principles of the present disclosure. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION OF THE INVENTION

In the following description, for purposes of explanation, numerous specific details are set forth in order to provide a thorough understanding of the present disclosure. It will be apparent, however, to one skilled in the art that the present disclosure can be practiced without these specific details. In other instances, apparatus and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. The use of any term should not be taken to limit the spirit and scope of embodiments of the present invention.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

As discussed in the background section, measurement accuracy of flowmeters degrades because of presence of upstream flow distorting features and unexpected changes in physical properties of fluids passing through the flowmeter. The impact of the flow distorting features on the measurement accuracy depends on the flow rate itself or flow regime. Variation in the physical properties of the fluid can also impair flowmeter measurement accuracy. A limited number of attempts have been made to develop models to compute flowmeter field error. The models usually solve physics-based equations to calculate a corrected calibration factor under field conditions. Such models replicate the flow distorting features (like a bend or valve) and generate a flow profile under the influence of the flow distorting features. The models then solve equations to calculate an output signal. The ratio of the output signal and the flowrate or velocity is the corrected calibration factor.

A gap in the model-based techniques is that while intensity of flow distortion depends on the shape, size, orientation, and distance of the flow distorting features from the flowmeter, it also depends on the flow regime (i.e., type of flow-laminar, transitional, or turbulent). In general, fluids in the laminar regime undergo severe distortion than those in the transitional or turbulent regime. However, no model accounts for change in fluid physical properties (i.e., the flow regime) while calculating calibration factor for the flowmeter thereby, impacting the measurement accuracy of the flowmeter.

To overcome these and other problems, the present disclosure provides techniques (methods and systems) for flowrate measurement correction of a flowmeter while taking into account prevailing flow regime and/or fluid properties. Specifically, the present disclosure describes a novel physics-based model (which can also be termed a digital twin of a flowmeter) which besides accounting for flow distorting features also accounts for the flow regime of the fluid and changes in the fluid physical properties while computing the calibration factor under a given flow distorting feature.

Thus, the present disclosure enables accurate measurement of flowrate during flow distortion of fluid in a flow pipe. The accurate measurement of flowrate is critical in industrial processes (such as, but not limited to, water treatment plants, oil plants, and pharmaceutical industries etc.) to ensure optimization of such industrial processes. Therefore, the techniques of the present disclosure reduce adverse impact on industrial processes by providing accurate reading of the flowrate. Furthermore, the techniques of the present disclosure avoid wet re-calibration (i.e., removal of flowmeter from field and shipment to laboratory for determining corrected calibration factor) because the techniques of present disclosure are model-based (dry calibration).

In general, a flowmeter is an instrument which is used for measuring flowrate of fluids and gases in fields (industries, plants, and homes etc.). There are many types of flowmeters available today including, but limited to, electromagnetic flowmeter, ultrasonic flowmeter, vortex flowmeter, Coriolis meter, thermal mass flowmeter, turbine flowmeter, and several other flowmeters (or other sensors like temperature sensors) etc. A flow meter works by measuring the amount of fluid passing through or around the flow meter. Different types of flowmeters work in different ways, but with the same end goal i.e., to provide the most accurate measurements of flowrate. For example, an electromagnetic (EM) flowmeter works on Faraday's law of electromagnetic induction. The EM flowmeter comprises a pipe with an insulating liner (not shown) inside the pipe and in contact with the fluid in the pipe. On either side, the EM flowmeter includes a pair of coils, including a top coil and a bottom coil which are powered by currents for generating electromagnetic fields. Essentially, the generated electromagnetic field interacts with fluid velocity and produces an output signal (e.g., an induced electromotive force (EMF) or electrical signal) within the fluid domain. To measure the output signal, the EM flowmeter includes on either side, a pair of electrodes. In an embodiment, the EM flowmeter may comprise a display for displaying the determined flowrate of fluid in the flow pipe.

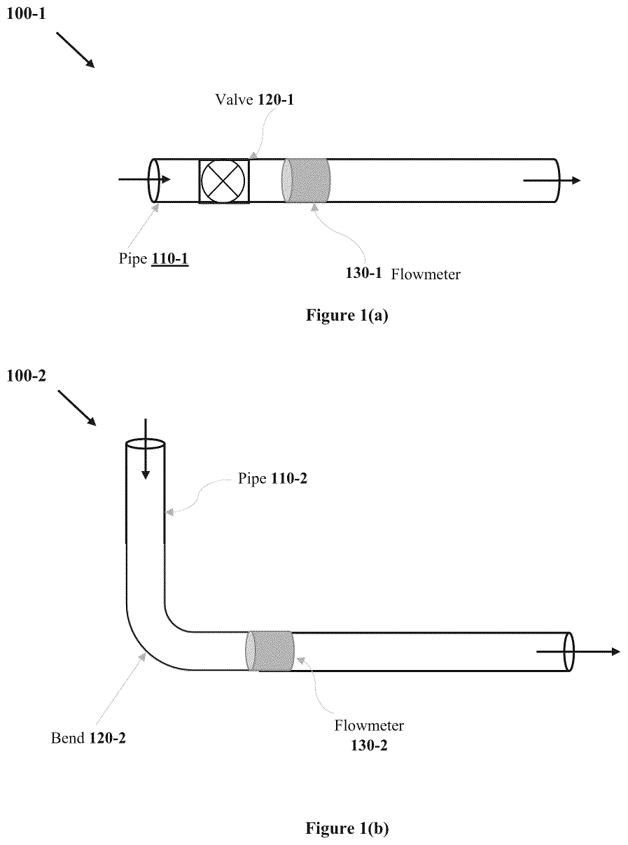

Generally, being proportional to velocity or flowrate, the output signal (i.e., EMF in case of EM flowmeter) can be used to estimate the flowrate, by referring to a calibration factor provided during laboratory testing. The calibration factor is or directly related to a ratio of output signal and flowrate obtained under ideal laboratory conditions, where enough pipe length on either side of the flowmeter is ensured to avoid flow distortion. However, when the flowmeter is used in fields (e.g., industries), there may be situations where the flowmeter may be positioned near to an upstream or downstream flow distorting feature (e.g., a bend or a valve) and flow of fluid through the flowmeter may undergo distortion, resulting in flow measurement error or inaccurate flowrate measurement. This is further illustrated in FIGS. 1(a) and 1(b).

Referring now to FIG. 1(a), which illustrates an exemplary arrangement 100-1 showing a section of a straight flow pipe having a flowmeter mounted therein/thereon, in accordance with some embodiments of the present disclosure. The arrangement 100-1 comprises a section of a cylindrical flow pipe 110-1 comprising a distorting feature (e.g., a valve 120-1) and a flowmeter 130-1. The flowmeter 130-1 may be mounted near to an upstream of the valve 120-1 for measuring flow of fluid through the pipe 110-1. So, any fluid passing through the flowmeter 130-1 may undergo distortion due to the valve 120-1, resulting in flow measurement error.

Referring now to FIG. 1(b), which illustrates another exemplary arrangement 100-2 showing a section of a bent flow pipe having a flowmeter mounted therein/thereon, in accordance with some embodiments of the present disclosure. The arrangement 100-2 comprises a section of a cylindrical flow pipe 110-2 comprising a distorting feature (e.g., a bend 120-2) and a flowmeter 130-2. The flowmeter 130-2 may be mounted near to an upstream of the bend 120-2 for measuring flow of fluid through the pipe 110-2. Since the distorting feature is very near to the flowmeter 130-2, any fluid passing through the flowmeter 130-2 may undergo distortion, resulting in flow measurement error (or inaccurate flowrate measurement).

In one non-limiting embodiment of the present disclosure, the intensity of the flow measurement error may depend on the amount of distortion caused by the flow distorting feature 120-1, 120-2 (collectively referred as 120) which in turn depends on several factors including flow distorting parameters (e.g., a geometry, orientation, and/or and dimensions of the flow distorting feature 120); physical and operational parameters of the flowmeter 130-1 130-2 (collectively referred as 130); a current flowrate value measured by the flowmeter 130, physical properties of fluid, and geometric features of the pipe 110.

In one non-limiting embodiment, the flow distorting parameters may comprise, but not limited to, a shape of the flow distorting feature 120 at an upstream or a downstream of the flowmeter 130, a size of the distorting feature 120 at the upstream or the downstream of the flowmeter 130, an orientation of the flow distorting feature 120 with respect to the flowmeter 120, and a distance of the flow distorting feature 120 from the flowmeter 130. In one embodiment, the orientation of the flow distorting feature 120 with respect to the flowmeter 120 may describe a bend angle/curvature of the flow distorting feature 120 (e.g., in case of a bend). In another embodiment, the orientation of the flow distorting feature 120 with respect to the flowmeter 120 may describe a percentage opening of the flow distorting feature 120 (e.g., in case of a valve).

In one non-limiting embodiment of the present disclosure, the physical parameters of the flowmeter 130 may comprise a shape and a size of the flowmeter 130 and/or its components. The operational parameters of the flowmeter 130 may comprise the conditions under which the flowmeter 130 is operating including operating temperature, line pressure, a current flowrate measured by the flowmeter 130, an original calibration factor of the flowmeter 130 (i.e., a calibration factor obtained by laboratory testing simulating ideal conditions) etc.

In one non-limiting embodiment of the present disclosure, the physical properties of the fluid may comprise density, viscosity, conductivity, and surface tension, but not limited thereto. The geometric features of the pipe 110 may comprise a length, diameter, and thickness of the pipe 110, an entry length in terms of pipe internal diameter, but not limited thereto.

In one non-limiting embodiment of the present disclosure, the intensity of flow measurement error also depends on a flow regime. In general, the flow regime describes a type or nature of fluid flow through the pipe 110. The fluid flowing through the pipe 110 may have a flow regime from a plurality of flow regimes comprising a laminar flow regime, a turbulent flow regime, and a transition flow regime. The flow regime plays an important role in design and operation of any fluid system including the flowmeter 130.

The present disclosure takes into account the flow regime along with other parameters for determining a corrected calibration factor of the flowmeter 130 so as to eliminate the flow measurement error and provide accurate flowrate measurements.

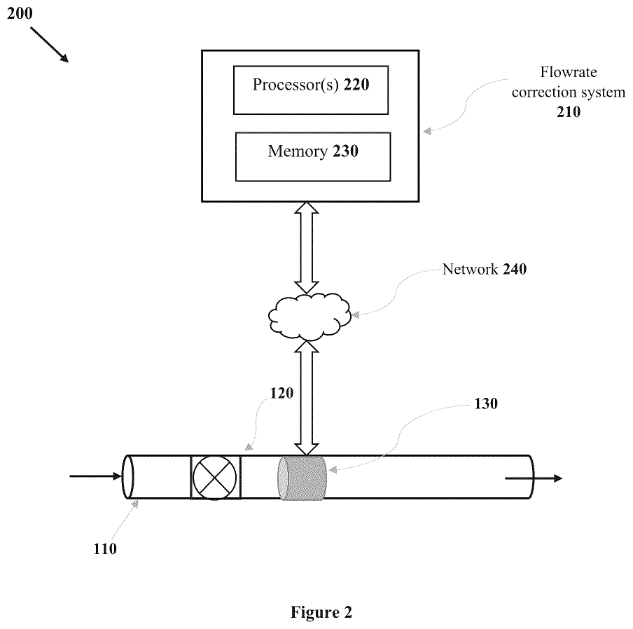

Referring now to FIG. 2, which illustrates an exemplary system 200 for correcting flowrate measurement of a flowmeter 130, in accordance with some embodiments of the present disclosure. The system 200 may comprise at least one flowmeter 130 mounted on a structure 110 (e.g., a pipe) and a flowmeter correction system 210 communicatively coupled with the flowmeter 130 via a network 240. The pipe 110 may comprise at least one flow distorting feature 120 near the flowmeter 130. The flowmeter may be located upstream of the flow distorting feature 120. The flowmeter correction system 210 may comprise at least one processor 220 and a memory 230. In one non-limiting embodiment, the flowmeter 130 may also comprise at least one processor and memory (not shown). The flowmeter 130 may also comprise various interfaces and transceivers for establishing wired and/or wireless communication with one or more devices/systems (e.g., the flowrate correction system 210).

The network 240 may comprise a data network such as, but not restricted to, the Internet, Local Area Network (LAN), Wide Area Network (WAN), Metropolitan Area Network (MAN), etc. In certain embodiments, the network 240 may include a wireless network, such as, but not restricted to, a cellular network and may employ various technologies including Enhanced Data rates for Global Evolution (EDGE), General Packet Radio Service (GPRS), Global System for Mobile Communications (GSM), Internet protocol Multimedia Subsystem (IMS), Universal Mobile Telecommunications System (UMTS) etc. In one embodiment, the network 240 may include or otherwise cover networks or subnetworks, each of which may include, for example, a wired or wireless data pathway.

The at least one processor 220 may include, but not restricted to, a general-purpose processor, a Field Programmable Gate Array (FPGA), an Application Specific Integrated Circuit (ASIC), a Digital Signal Processor (DSP), microprocessors, microcomputers, micro-controllers, central processing units, state machines, logic circuitries, and/or any devices that manipulate signals based on operational instructions. A processor may also be implemented as a combination of computing devices, e.g., a combination of a DSP and a microprocessor, a plurality of microprocessors, one or more microprocessors in conjunction with a DSP core, or any other such configuration.

The memory 230 may be communicatively coupled to the at least one processor 220. The memory 230 may comprise various instructions, information related to one or more flowmeters, fluids, pipes, one or more equations etc. The memory 230 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth.

In one non-limiting embodiment of the present disclosure, the at least one processor 220 may receive one or more parameters related to the flowmeter 130, the flow distorting feature 120, the fluid passing through the pipe 110, and/or other miscellaneous parameters, as discussed above. For instance, the at least one processor 220 may receive the flow distorting parameters; physical and operational parameters of the flowmeter 130; a current flowrate value measured by the flowmeter 130, physical properties of fluid. In one embodiment, these parameters may be received from the flowmeter 130 and its associated infrastructure. In another embodiment, these parameters may be supplied by a user to the flowrate correction system 210. The at least one processor 220 may also receive data related to one or more other properties related to the fluid such as temperature, pressure, specific volume, specific weight, specific gravity etc. In an embodiment, the associated infrastructure of the flowmeter 130 may refer to the pipe 110 into which the flowmeter 130 is installed and/or the features upstream and/or downstream of the flowmeter 130 like valves, bends etc.

In one non-limiting embodiment, the at least one processor 220 may determine a particular flow regime associated with the fluid passing through the pipe 110 from a plurality of flow regimes based on one or more of the received parameters. The plurality of flow regimes may comprise a laminar flow regime, a transitional flow regime, and a turbulent flow regime. In one embodiment, the at least one processor may determine the flow regime based on the current flowrate value measured by the flowmeter 130. Although the current flowrate value is not the corrected flowrate value, but it is accurate enough to determine the flow regime of the fluid.

In one non-limiting embodiment, the at least one processor 220 may determine/calculate a Reynolds number (denoted as ‘Re’) based on the current flowrate value. The Reynolds number is calculated using conventionally known techniques based at least on the flowrate/flow velocity measured by the flowmeter 130. In general, the Reynolds number is a dimensionless number, whose value gives an idea of whether the fluid flow is a turbulent or laminar or transitional.

The at least one processor 220 may then determine the flow regime of the fluid passing through the pipe based on the calculated Reynolds number. For instance, the at least one processor 220 may compare the calculated Reynolds number with present numbers for selecting the flow regime of the fluid from a plurality of flow regimes. The at least one processor 220 may select the laminar flow regime from the plurality of flow regimes when the Reynolds number is less or equal to a first value. Further, the at least one processor 220 may select the transitional flow regime from the plurality of flow regimes when the Reynolds number is between the first value and a second value. Furthermore, the at least one processor 220 may select the turbulent flow regime from the plurality of flow regimes when the Reynolds number is greater than or equal to the second value. It may be noted here that the second value is greater than the first value.

Consider an example, where the first value is 2000 and the second value of 3000. Now, if the value of Reynolds Number is less than or equal to 2000, the flow regime is laminar flow regime; if the value of Reynolds Number is more than 2000 and less than 3000, the flow regime is transitional flow regime; and if the value of Reynolds Number is greater than or equal to 3000, the flow regime is transitional flow regime. It may be noted that these limits are only for exemplary purpose and can tolerate a variation of +/−20%.

In general, each flow regime may have some equations (e.g., energy equations, momentum equations, mass equations etc.) associated with it. The at least one processor 220 may select at least one flow equation from a plurality of flow equations based on the selected flow regime. For instance, the at least one processor 220 may select a laminar flow momentum equation and associated equations when the flow regime is a laminar flow regime. The laminar flow momentum equations and associated equations may comprise at least one of: mass conservation equation, momentum conservation equation, and energy conservation equation for the laminar flow regime.

Similarly, when the flow regime is a transitional flow regime, the at least one processor 220 may select a transition fluid flow momentum equation and associated equations. The transition fluid flow momentum equation and associated equations may comprise at least one of: mass conservation equation, momentum conservation equation, and energy conservation equation associated with the transitional flow regime. The transition fluid flow momentum equation and associated equations may additionally comprise wall function equations.

Further, the at least one processor 220 may select a turbulent flow equation and associated equations when the flow regime is a turbulent flow regime. The turbulent flow equation and associated equations may comprise at least one of: mass conservation equation, momentum conservation equation, and energy conservation equation associated with the turbulent flow regime. The turbulent flow equation and associated equations may additionally comprise kinetic energy production equation, dissipation, and wall function equations.

In one non-limiting embodiment of the present disclosure, the at least one processor 220 may then compute an output signal of the flowmeter 130 based on the selected at least one flow equation and further based on one or more of the received parameters (i.e., the flow distortion related parameters, the flowmeter physical and operational parameters, and the fluid physical properties). In one embodiment, the at least one processor may additionally use one or more electromagnetic equations and/or physics-based equations for computing the output signal. The electromagnetic and/or physics based equations may comprise Maxwell's equations: Gauss law equation, Gauss law equation for magnetism, Faraday's law of induction, and/or Ampere's circuital law.

In one non-limiting embodiment of the present disclosure, the at least processor 220 may determine a corrected calibration factor for the flowmeter 130 based on the determined output signal and the received current flowrate value measured by the flowmeter 130. Particularly, the at least one processor 220 may divide the determined output signal by the received current flowrate value to determine the corrected calibration factor.

In one non-limiting embodiment of the present disclosure, the at least one processor 220 may provide transmit the corrected calibration factor. In one embodiment, the corrected calibration factor may be transmitted to the flowmeter 130 or to any other computing device which may use the corrected calibration factor for correcting flowrate measurements of the flowmeter 130. In one embodiment, the original calibration factor of the flowmeter 130 (i.e., a calibration factor obtained by laboratory testing simulating ideal conditions) may be replaced with the corrected calibration factor for correcting the flowrate measurements of the flowmeter 130.

In the exemplary embodiment of FIG. 2, the flowrate correction system 210 has been shown at a remote location from the flowmeter 130 and is communicating with the flowmeter 130 via the network 240. However, the present disclosure is not limited thereto and the flowrate correction system 210 may be implemented as a part of the flowmeter 130 itself. The various operations described above may be performed by a flowmeter processor (not shown) provided with the flowmeter 130. In other words, the present disclosure may facilitate a smart flowmeter with inbuilt self-calibrating computational model that can provide the corrected calibration factor for correcting the flowrate measurements of the flowmeter 130.

In one non-limiting embodiment of the present disclosure, the flowrate correction system 210 may be run offline before installation of the flowmeter 130 or during operation of the flowmeter 130. In one non-limiting embodiment, flowrate correction system 210 may dynamically update the calibration factor of the flowmeter 130 whenever there is change in any parameter associated with the fluid/flowmeter/pipe. For example, if an existing valve near the flowmeter 130 is replaced with a new value having different geometry/configuration, or if a new flow distorting feature is added near the flowmeter 130, or if a fluid flowing through the pipe is changed, and like, then the calibration factor might need to be updated. In such scenarios, the flowrate correction system 210 may dynamically receive feedback of various parameters (e.g., flow distorting features and/or fluid properties) from the flowmeter 130 and/or associated devices. For example, the flowmeter processor may dynamically transmit parameters necessary for correcting the flowrate measurements to the flowrate correction system 210 which may then dynamically calculate the corrected calibration factor using the techniques of the present disclosure and may then replace an existing calibration factor of the flowmeter 130.

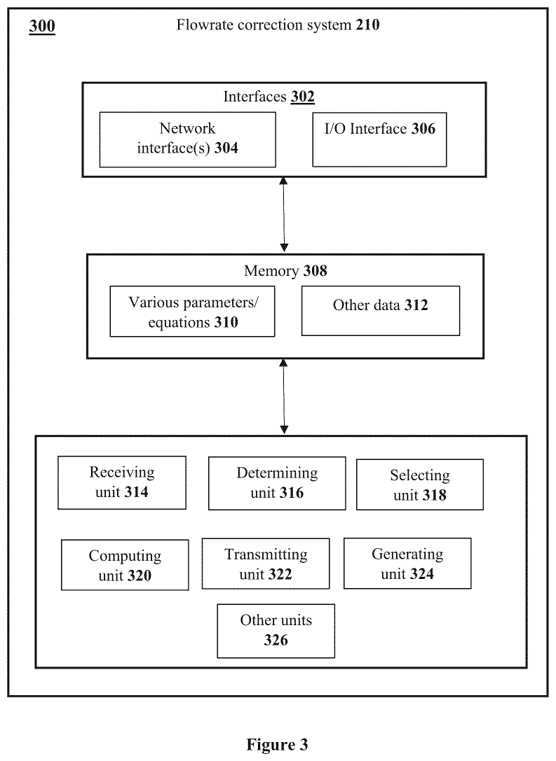

Referring now to FIG. 3, which shows a block diagram of the flowrate correction system 210, in accordance with some embodiments of the present disclosure. In one non-limiting embodiment of the present disclosure, the flowrate correction system 210 may comprise various other hardware components such as various interfaces 302, memory 308, and various units or means as shown in FIG. 3. The units may comprise a receiving unit 314, a determining unit 316, a selecting unit 318, a computing unit 320, a transmitting unit 322, a generating unit 324, and various other units 326. The other units 326 may comprise a display unit, a calibrating unit etc. In an embodiment, the units 314-326 may be dedicated hardware units capable of executing one or more instructions stored in the memory 308 for performing various operations of the flowrate correction system 210. In another embodiment, the units 314-326 may be software modules stored in the memory 308 which may be executed by the at least one processor 220 for performing the operations of the flowrate correction system 210.

The interfaces 302 may include a variety of software and hardware interfaces, for example, a web interface, a graphical user interface, an input device-output device (I/O) interface 306, a network interface 304 and the like. The I/O interfaces 306 may allow the flowrate correction system 210 to interact with other devices (e.g., the flowmeter 130) directly or through other devices. The network interface 304 may allow the flowrate correction system 210 to interact with one or more devices either directly or via the network 240.

The memory 308 may comprise various parameters and/or equations 310 (discussed above), and other various types of data 312 (such as one or more computer executable instructions). The memory 308 may be same as the memory 230.

In the present disclosure, the pipes 110-1, 110-2 have been collectively referred by reference numeral 110. In the present disclosure it has been shown the fluid is flowing through pipes. However, the present disclosure is not limited thereto, and the techniques described in the disclosure are equally applicable for measuring flowrate of fluid passing through any structure at/on/in which a flowmeter can be mounted. Further, the valve 120-1 and the bend 120-2 have been collectively referred as flow distorting features/elements 120. Furthermore, the flowmeters 130-1 and 130-2 have been collectively referenced using the reference numeral 130. The techniques of the present disclosure are equally applicable for pipes having more than one flow distorting features.

The present disclosure provides reliable and accurate flowmeters which are capable of providing quality performance under extreme conditions. Further, due to model-based approach of present disclosure, the need to remove the flowmeter from field for calibration is avoided thereby, saving production time. Furthermore, the techniques of present disclosure ensure flow profile independence without inducing pressure drop or additional energy expenditure.

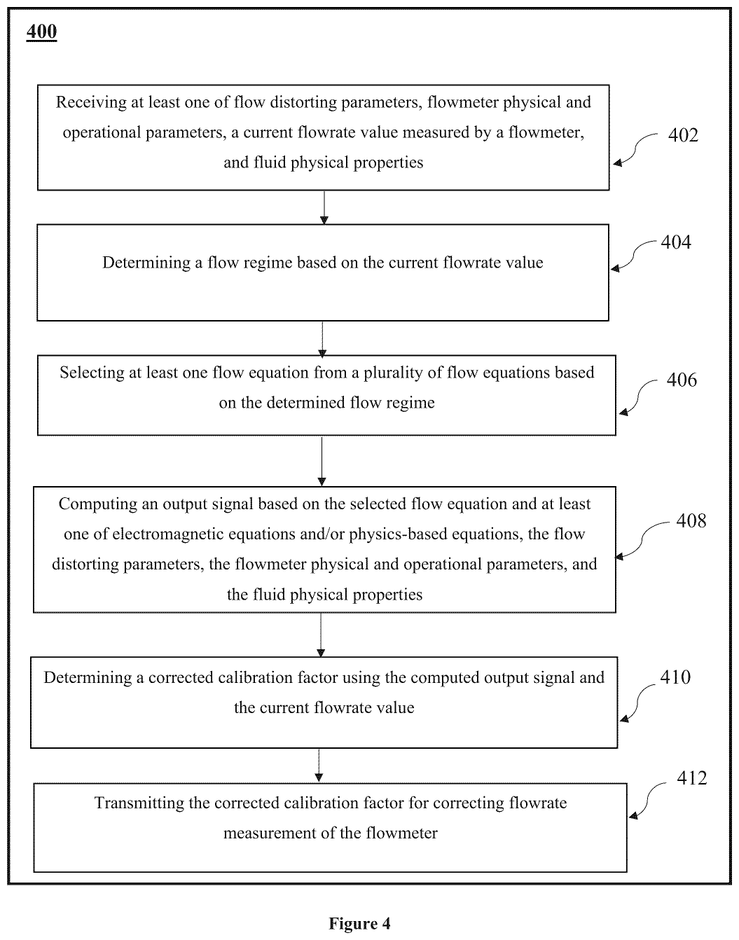

Referring now to FIG. 4, a flowchart is described illustrating an exemplary method 400 for correcting flowrate measurements of a flowmeter 130, according to an embodiment of the present disclosure. The method 400 is merely provided for exemplary purposes, and embodiments are intended to include or otherwise cover any methods or procedures for correcting flowrate measurements of the flowmeter 130.

The method 400 may include, at block 402, receiving at least one of flow distorting parameters, flowmeter physical and operational parameters, a current flowrate value measured by the flowmeter 130, and fluid physical properties. The operations of block 402 may be performed by the at least one processor 220 of FIG. 2 or by the receiving unit 314 of FIG. 3.

In one non-limiting embodiment, the flow distorting parameters may comprise a shape of a flow distorting feature 120 at an upstream or a downstream of the flowmeter 130, a size of the flow distorting feature 120 at the upstream or the downstream of the flowmeter 130, an orientation of the flow distorting feature 120 with respect to the flowmeter 130, and a distance of the flow distorting feature 120 from the flowmeter 130.

In another non-limiting embodiment, flowmeter physical parameters may comprise a shape and a size of flowmeter components.

At block 404, the method 400 may include determining a flow regime based on the current flowrate value. The operations of block 404 may be performed by the at least one processor 220 of FIG. 2 or by the determining unit 316 of FIG. 3.

In one non-limiting embodiment of the present disclosure, the operation of determining the flow regime may comprise calculating Reynolds number based on the current flowrate value; and selecting a flow regime from a plurality of flow regimes based on the calculated Reynolds number.

In one non-limiting embodiment of the present disclosure, the plurality of flow regimes may comprise a laminar flow regime, a transitional flow regime, and a turbulent flow regime. Further, the operation of selecting the flow regime from the plurality of flow regimes may comprise selecting the laminar flow regime when the Reynolds number is less or equal to a first value; selecting the transitional flow regime when the Reynolds number is between the first value and a second value, where the second value is greater than the first value; and selecting the turbulent flow regime when the Reynolds number is greater than or equal to the second value.

At block 406, the method 400 may include selecting at least one flow equation from a plurality of flow equations based on the determined flow regime. The operations of block 406 may be performed by the at least one processor 220 of FIG. 2 or by the selecting unit 318 of FIG. 3.

In one non-limiting embodiment of the present disclosure, selecting the at least one flow equation from the plurality of flow equations may comprise selecting a laminar flow momentum equation and associated equations when the flow regime is a laminar flow regime; selecting a transition fluid flow momentum equation and associated equations when the flow regime is a transitional flow regime; and selecting a turbulent flow equation and associated equations when the flow regime is a turbulent flow regime.

At block 408, the method 400 may include computing an output signal based on the selected flow equation and at least one of electromagnetic equations and/or physics-based equations, the flow distorting parameters, the flowmeter physical and operational parameters, and the fluid physical properties. The operations of block 408 may be performed by the at least one processor 220 of FIG. 2 or by the computing unit 320 of FIG. 3.

At block 410, the method 400 may include determining a corrected calibration factor using the computed output signal and the current flowrate value. The operations of block 410 may be performed by the at least one processor 220 of FIG. 2 or by the determining unit 316 of FIG. 3.

In one non-limiting embodiment of the present disclosure, determining the corrected calibration factor using the computed output signal and the current flowrate value may comprise dividing the computed output signal by the current flowrate value to determine the corrected calibration factor.

At block 412, the method 400 may include transmitting the corrected calibration factor for correcting flowrate measurement of the flowmeter 130. The operations of block 412 may be performed by the at least one processor 220 of FIG. 2 or by the transmitting unit 322 of FIG. 3.

The order in which the various operations of the method 400 are described is not intended to be construed as a limitation, and any number of the described method blocks can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

The various operations of method described above may be performed by any suitable means capable of performing the corresponding functions. The means may include various hardware and/or software component(s) and/or module(s), including, but not limited to the at least one processor 220 of FIG. 2 and the various units of FIG. 3. Generally, where there are operations illustrated in Figures, those operations may have corresponding counterpart means-plus-function components.

It may be noted here that the subject matter of some or all embodiments described with reference to FIGS. 1-3 may be relevant for the methods and system and the same is not repeated for the same of brevity.

In a non-limiting embodiment of the present disclosure, one or more non-transitory computer-readable media may be utilized for implementing the embodiments consistent with the present disclosure. A computer-readable media refers to any type of physical memory (such as the memory 230) on which information or data readable by a processor may be stored. Thus, a computer-readable media may store one or more instructions for execution by the at least one processor 220, including instructions for causing the at least one processor 220 to perform steps or stages consistent with the embodiments described herein. The term “computer-readable media” should be understood to include tangible items and exclude carrier waves and transient signals. By way of example, and not limitation, such computer-readable media can comprise Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

Thus, certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCE NUMERALS

### Reference Number Description

100-1, 100-2 Arrangements
110-1, 110-2, 110 Flow pipe
130-1, 130-2, 130 Flowmeter
120-1, 120-2, 120 Flow distorting feature
200 System
210 Flowrate correction system
220 Processor
230 Memory
240 Network
300 Block diagram
302 Interfaces
304 Network interface
306 I/O interface
308 Memory
314 Receiving unit
316 Determining unit
318 Selecting unit
320 Computing unit
322 Transmitting unit
324 Generating unit
326 Other units
400 Method

What is claimed is:

1. A method for correcting flowrate measurements of a flowmeter, the method comprising:
receiving at least one of flow distorting parameters, flowmeter physical and operational parameters, a current flowrate value measured by the flowmeter, and fluid physical properties;
determining a flow regime based on the current flowrate value;
selecting at least one flow equation from a plurality of flow equations based on the determined flow regime;
computing an output signal based on the selected flow equation and at least one of electromagnetic equations and/or physics-based equations, the flow distorting parameters, the flowmeter physical and operational parameters, and the fluid physical properties;
determining a corrected calibration factor using the computed output signal and the current flowrate value; and
transmitting the corrected calibration factor for correcting flowrate measurement of the flowmeter.

2. The method as claimed in claim 1, wherein the flow distorting parameters comprise a shape of a flow distorting feature at an upstream or a downstream of the flowmeter, a size of the flow distorting feature at the upstream or the downstream of the flowmeter, an orientation of the flow distorting feature with respect to the flowmeter, and a distance of the flow distorting feature from the flowmeter.

3. The method as claimed in claim 1, wherein the flowmeter physical parameters comprise a shape and a size of flowmeter components.

4. The method as claimed in claim 1, wherein determining the flow regime comprises:
calculating Reynolds number based on the current flowrate value; and
selecting a flow regime from a plurality of flow regimes based on the calculated Reynolds number.

5. The method as claimed in claim 4, wherein the plurality of flow regimes comprises a laminar flow regime, a transitional flow regime, and a turbulent flow regime.

6. The method as claimed in claim 5, wherein selecting the flow regime from the plurality of flow regimes comprises:
selecting the laminar flow regime when the Reynolds number is less or equal to a first value;
selecting the transitional flow regime when the Reynolds number is between the first value and a second value, where the second value is greater than the first value; and
selecting the turbulent flow regime when the Reynolds number is greater than or equal to the second value.

7. The method as claimed in claim 1, wherein determining the corrected calibration factor using the computed output signal and the current flowrate value comprises dividing the computed output signal by the current flowrate value to determine the corrected calibration factor.

8. The method as claimed in claim 1, wherein selecting the at least one flow equation from the plurality of flow equations comprises:
selecting a laminar flow momentum equation and associated equations when the flow regime is a laminar flow regime;
selecting a transition fluid flow momentum equation and associated equations when the flow regime is a transitional flow regime; and
selecting a turbulent flow equation and associated equations when the flow regime is a turbulent flow regime.

9. A flowrate correction system for correcting flowrate measurements of a flowmeter, the flowrate correction system comprising:
a processor; and
a memory communicatively coupled to the processor, wherein the memory stores processor-executable instructions, which on execution, cause the processor to:
receive at least one of flow distorting parameters, flowmeter physical and operational parameters, a current flowrate value measured by the flowmeter, and fluid physical properties;
determine a flow regime based on the current flowrate value;
select at least one flow equation from a plurality of flow equations based on the flow regime;
compute an output signal based on the selected flow equation at least one of electromagnetic equations and/or physics-based equations, the flow distorting parameters, the flowmeter physical and operational parameters, and the fluid physical properties;
determine a corrected calibration factor using the computed output signal and the current flowrate value; and
transmit the corrected calibration factor for correcting flowrate measurement of the flowmeter.

10. The flowrate correction system as claimed in claim 9, wherein the flow distorting parameters comprise a shape of a flow distorting feature at an upstream or a downstream of the flowmeter, a size of the flow distorting feature at the upstream or the downstream of the flowmeter, an orientation of the flow distorting feature with respect to the flowmeter, and a distance of the flow distorting feature from the flowmeter.

11. The flowrate correction system as claimed in claim 9, wherein the flowmeter physical parameters comprise a shape and a size of flowmeter components.

12. The flowrate correction system as claimed in claim 9, wherein to determine the flow regime, the processor is configured to:
calculate Reynolds number based on the current flowrate value; and
select a flow regime from a plurality of flow regimes based on the calculated Reynolds number, wherein the plurality of flow regimes comprises a laminar flow regime, a transitional flow regime or a turbulent flow regime.

13. The flowrate correction system as claimed in claim 12, wherein the processor is configured to:
select the laminar flow regime when the Reynolds number is less or equal to a first value;
select the transitional flow regime when the Reynolds number is between the first value and a second value, where the second value is greater than first value; and
select the turbulent flow regime when the Reynolds number is greater than or equal to the second value.

14. The flowrate correction system as claimed in claim 9, wherein to determine a corrected calibration factor, the processor is configured to divide the computed output signal by the current flowrate value to determine the corrected calibration factor.

15. The flowrate correction system as claimed in claim 9, wherein to select the at least one flow equation from the plurality of flow equations, the processor is configured to:
select a laminar flow momentum equation and associated equations when the flow regime is a laminar flow regime;
select a transition fluid flow momentum equation and associated equations when the flow regime is a transitional flow regime; and
select a turbulent flow equation and associated equations when the flow regime is a turbulent flow regime.
